(19) United States
(12) Patent Application Publication
(10) Pub. No.: US 2026/0011951 A1
(43) Pub. Date: Jan. 8, 2026

(54) Seal and Connector

(71) Applicants: Tyco Electronics (Suzhou) Ltd., Suzhou City (CN); Tyco Electronics (Shanghai) Co., Ltd., Shanghai (CN)

(72) Inventors: Jinjun (Zack) Ze, Suzhou (CN); Jun Zong, Shanghai (CN); Shiyuan (Shine) Fan, Shanghai (CN)

(73) Assignees: Tyco Electronics (Suzhou) Ltd., Suzhou City (CN); Tyco Electronics (Shanghai) Co., Ltd., Shanghai (CN)

(21) Appl. No.: 19/262,778

(22) Filed: Jul. 8, 2025

(30) Foreign Application Priority Data
Jul. 8, 2024 (CN) 202421603079.2

(51) Int. Cl. H01R 13/52

(52) U.S. Cl. CPC H01R 13/5205

(57) ABSTRACT

A seal includes an elastic body having a through hole receiving a terminal with a cable and an inner sealing rib extending circumferentially around the through hole and interference fit with the cable to form a seal with the cable. An inner contour line of the inner sealing rib is elliptical. A major axis and a minor axis of the inner contour line respectively correspond to a major side and a minor side of a rectangular section of the terminal.

### CROSS-REFERENCE TO RELATED APPLICATION

This application claims the benefit of the filing date under 35 U.S.C. § 119(a)-(d) of Chinese Patent Application No. 202421603079.2, filed on Jul. 8, 2024.

### FIELD OF THE INVENTION

The present invention relates to a seal and a connector comprising the seal.

### BACKGROUND OF THE INVENTION

Cable holes in seals are typically designed as circular holes, with raw materials selected from low-hardness silicone, such as silicone with a Shore A hardness of approximately 20 degrees. However, in new oil-resistant application environments, the raw materials for the seals must be replaced with oil-resistant materials. But these materials also have obvious performance drawbacks, such as high hardness and poor toughness, etc. This may result in excessive force required to insert terminals and cables into the cable holes. Additionally, when rectangular-section terminals are inserted into the cable holes, major sides of the terminals tend to scrape the edges of the cable holes, leading to poor sealing. In order to solve these problems, in the prior art, an inner diameter of the cable holes is typically increased directly, which results in excessively small interference (i.e., interference fit) between the cable holes and the cables and reduced contact pressure, significantly reducing the sealing ability and thus greatly reducing sealing performance and sealing reliability.

### SUMMARY OF THE INVENTION

A seal includes an elastic body having a through hole receiving a terminal with a cable and an inner sealing rib extending circumferentially around the through hole and interference fit with the cable to form a seal with the cable. An inner contour line of the inner sealing rib is elliptical. A major axis and a minor axis of the inner contour line respectively correspond to a major side and a minor side of a rectangular section of the terminal.

### BRIEF DESCRIPTION OF THE DRAWINGS

Features of the present invention will become more apparent by describing in detail exemplary embodiments thereof with reference to the accompanying drawings, in which:

FIG. 1 shows an illustrative perspective view of a connector according to an exemplary embodiment of the present invention;

FIG. 2 shows an illustrative exploded view of the connector according to an exemplary embodiment of the present invention;

FIG. 3 shows an illustrative exploded view of a seal and a cable assembly according to an exemplary embodiment of the present invention;

FIG. 4 shows an illustrative perspective view of the seal and a terminal inserted into a through hole of the seal according to an exemplary embodiment of the present invention;

FIG. 5 shows a cross-sectional view of the seal according to an exemplary embodiment of the present invention;

FIG. 6 shows an illustrative schematic plan view of the seal according to an exemplary embodiment of the present invention;

FIG. 7 shows a cross-sectional view in a length direction of the seal according to an exemplary embodiment of the present invention;

FIG. 8 shows a cross-sectional view in a width direction of the seal according to an exemplary embodiment of the present invention; and

FIG. 9 shows a transverse cross-sectional view of the terminal according to an exemplary embodiment of the present invention.

### DETAILED DESCRIPTION

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

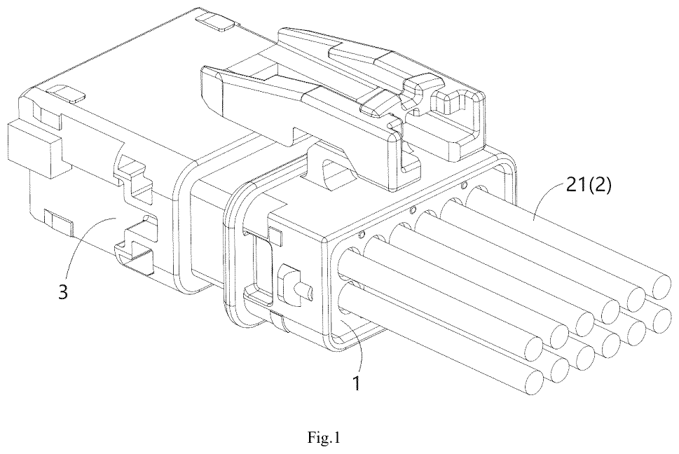

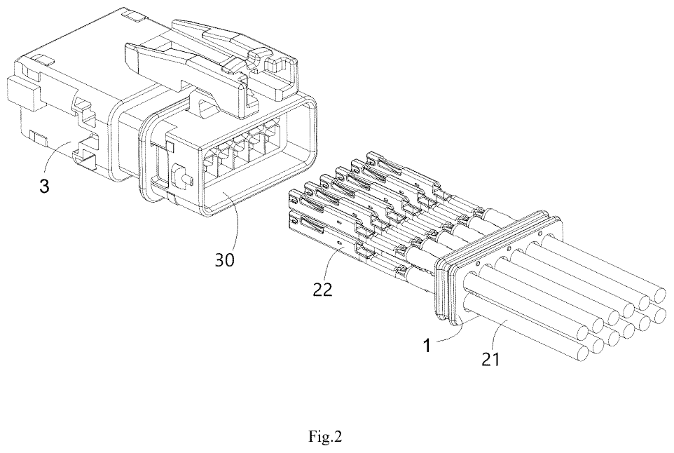

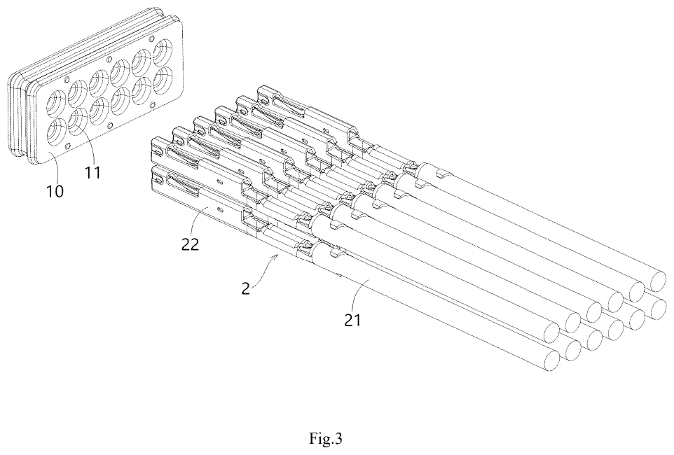

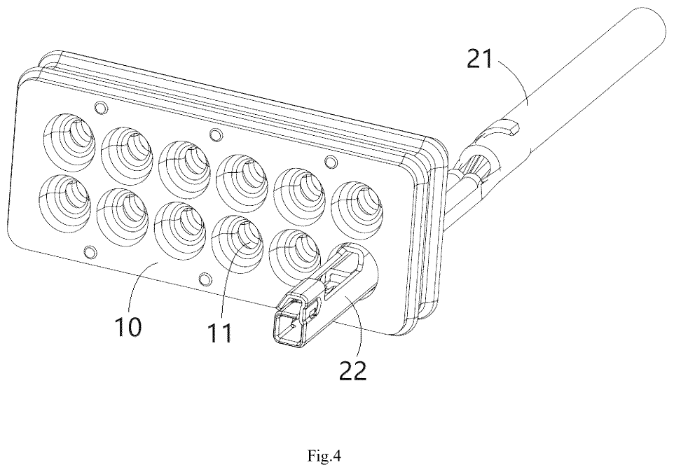

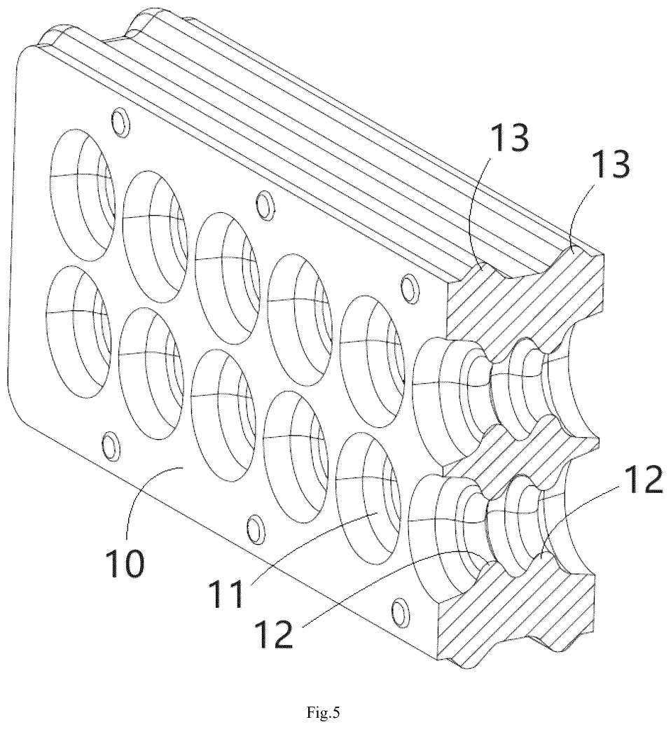

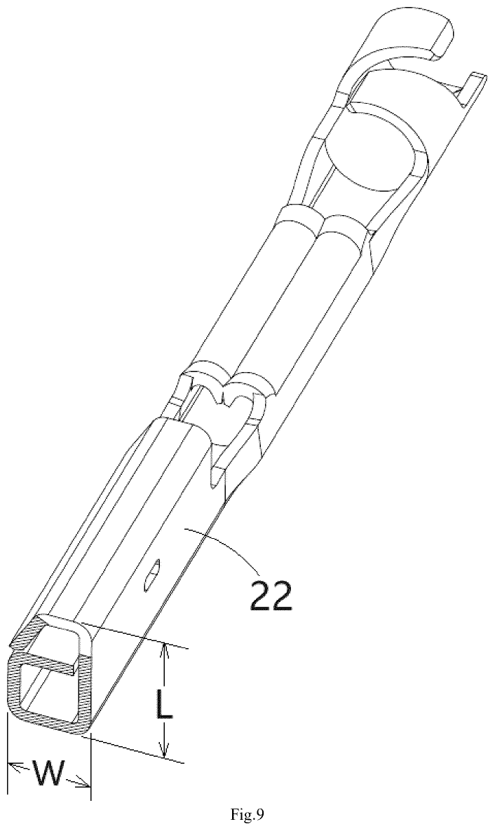

As shown in FIGS. 1 to 9, in an exemplary embodiment of the present invention, a seal 1 is disclosed. The seal 1 includes an elastic body 10 and at least one circumferential inner scaling rib 12, shown in FIG. 5. The elastic body 10 is formed with a through hole 11 which allows a rectangular terminal 22 with a cable 21 to pass through, as shown in FIG. 4. The at least one circumferential inner sealing rib 12 are formed in the through hole 11 for interference fit with the cable 21 to achieve sealing therebetween.

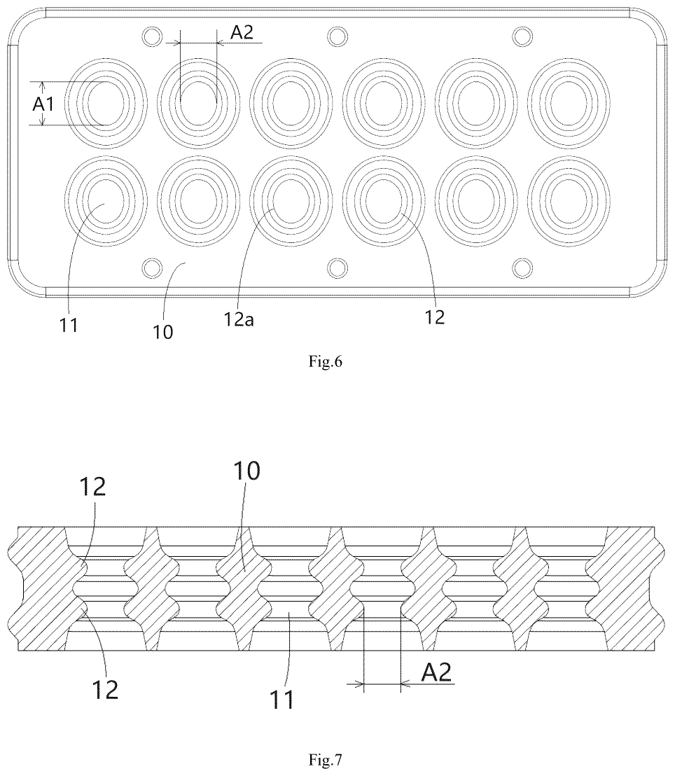

As shown in FIG. 6, in the illustrated embodiment, an inner contour line 12a of the inner sealing rib 12 is elliptical, and a major axis A1 and a minor axis A2 of the elliptical inner contour line 12a respectively correspond to a major side L and a minor side W of a rectangular section of the terminal 22, shown in FIG. 9, fixed on an end of the cable 21, so as to prevent the inner scaling rib 12 from being damaged when the terminal 22 passes through the through hole 11.

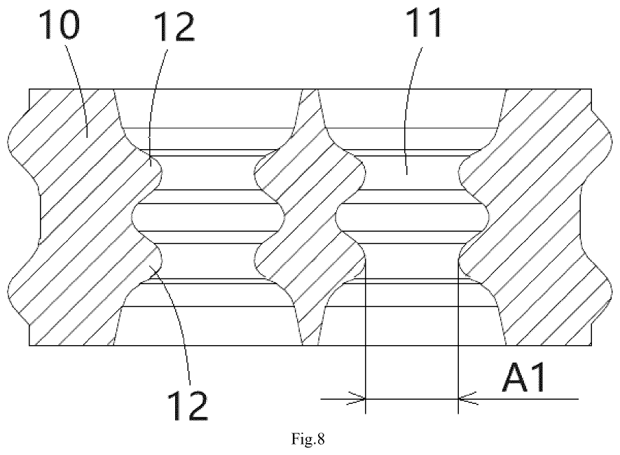

In the illustrated embodiment, the major axis A1 of the elliptical inner contour line 12a of the inner scaling rib 12 has a dimension smaller than a diameter of the cable 21 by a first value, so as to ensure an interference fit between the inner sealing rib 12 and the cable 21. The dimension of the major axis A1 of the elliptical inner contour line 12a of the inner sealing rib 12 is smaller than a dimension of the major side L of the rectangular section of the terminal 22 by a second value, and the second value is smaller than the first value. In the illustrated embodiment, the minor axis A2 of the elliptical inner contour line 12a of the inner sealing rib 12, shown in FIG. 7, has a dimension equal to, slightly smaller than or slightly larger than a dimension of the minor side W of the rectangular section of the terminal 22. In the present specification, the term “slightly” means within 10%.

As shown in FIGS. 5, 7, and 8, in the illustrated embodiment, a plurality of the circumferential inner sealing ribs 12 are formed in the through hole 11 of the elastic body 10, the plurality of circumferential inner sealing ribs 12 are spaced apart in an axial direction of the through hole 11, and the plurality of circumferential inner sealing ribs 12 are all in interference fit with the cable 21, so as to improve sealing performance and scaling reliability.

As shown in FIGS. 5, 7, and 8, in the illustrated embodiment, the through hole 11 includes an inlet portion, an outlet portion, and an intermediate portion between the inlet portion and the outlet portion, and the inner sealing rib 12 is formed on an inner peripheral surface of the intermediate portion of the through hole 11. In the illustrated embodiment, the inlet portion of the through hole 11 is outwardly flared in a trumpet shape to guide the insertion of the terminal 22 and the cable 21 into the through hole 11. In the illustrated embodiment, the inlet portion and the outlet portion of the through hole 11 are identical and both are outwardly flared in a trumpet shape, such that the seal 1 does not need to be distinguished between front and back sides during use.

As shown in FIGS. 1 to 9, in the illustrated embodiment, a plurality of the through holes 11 are formed in the elastic body 10 of the seal 1 to allow a plurality of cables 21 to respectively pass through.

As shown in FIGS. 1 to 9, in the illustrated embodiment, the elastic body 10 of the seal 1 has a cuboid shape, a length direction and a width direction of the elastic body 10 are respectively parallel to the minor axis A2 and the major axis A1 of the elliptical inner contour line 12a of the inner sealing rib 12, and a thickness direction of the elastic body 10 is parallel to an axial direction of the through hole 11. In the illustrated embodiment, the plurality of through holes 11 are arranged in rows and columns in the length direction and the width direction of the elastic body 10.

As shown in FIG. 5, in the illustrated embodiment, the seal 1 further includes at least one circumferential outer sealing rib 13 formed on an outer peripheral surface of the elastic body 10 for interference fit with an inner peripheral surface of a rear port 30 of an insulating housing 3 of a connector to achieve sealing therebetween. In the illustrated embodiment, a plurality of the circumferential outer sealing ribs 13 are formed on the outer peripheral surface of the elastic body 10, and the plurality of circumferential outer sealing ribs 13 are spaced apart in the thickness direction of the elastic body 10 and are all in interference fit with the inner peripheral surface of the rear port 30 of the insulating housing 3.

In the illustrated embodiment, the seal 1 is a one-piece injection molded part.

In another exemplary embodiment of the present invention, as shown in FIGS. 1-3, a connector is disclosed. The connector includes an insulating housing 3, the seal 1, and a cable assembly 2. The insulating housing 3 has a rear port 30. The seal 1 is inserted and mounted in the rear port 30 of the insulating housing 3. The cable assembly 2 includes a cable 21 and a terminal 22 fixed on an end of the cable 21. For example, the terminal 22 can be crimped onto the end of the cable 21. The terminal 22 and the cable 21 pass through the through hole 11 in the seal 1 such that the seal 1 is sleeved on the cable 21. The inner sealing rib 12 of the seal 1 is in interference fit with an outer peripheral surface of the cable 21 to achieve sealing between the seal 1 and the cable 21. The outer sealing rib 13 of the seal 1 is in interference fit with an inner peripheral surface of the rear port 30 of the insulating housing 3 to achieve sealing between the seal 1 and the insulating housing 3.

In the illustrated embodiment, the connector includes a plurality of cable assemblies 2, the plurality of cable assemblies 2 respectively passing through the plurality of through holes 11 in the seal 1.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and preceded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

1. A seal, comprising:
an elastic body having a through hole receiving a terminal with a cable; and
an inner sealing rib extending circumferentially around the through hole and interference fit with the cable to form a seal with the cable, an inner contour line of the inner sealing rib is elliptical, a major axis and a minor axis of the inner contour line respectively correspond to a major side and a minor side of a rectangular section of the terminal.

2. The seal according to claim 1, wherein the major axis of the inner contour line of the inner sealing rib has a dimension smaller than a diameter of the cable by a first value.

3. The seal according to claim 2, wherein the dimension of the major axis of the inner contour line of the inner sealing rib is smaller than a dimension of the major side of the rectangular section of the terminal by a second value.

4. The seal according to claim 3, wherein the second value is smaller than the first value.

5. The seal according to claim 1, wherein the minor axis of the inner contour line of the inner sealing rib has a dimension equal to, slightly smaller than, or slightly larger than a dimension of the minor side of the rectangular section of the terminal.

6. The seal according to claim 1, wherein the inner sealing rib is one of a plurality of inner sealing ribs formed in the through hole.

7. The seal according to claim 6, wherein the plurality of inner sealing ribs are spaced apart in an axial direction of the through hole and are all interference fit with the cable.

8. The seal according to claim 1, wherein the through hole includes an inlet portion, an outlet portion, and an intermediate portion between the inlet portion and the outlet portion, the inner sealing rib is formed on an inner peripheral surface of the intermediate portion of the through hole.

9. The seal according to claim 8, wherein the inlet portion of the through hole is outwardly flared in a trumpet shape and guides insertion of the terminal and the cable into the through hole.

10. The seal according to claim 9, wherein the inlet portion and the outlet portion of the through hole are identical and both are outwardly flared in the trumpet shape, the seal is identical on a front side and a back side.

11. The seal according to claim 1, wherein the through hole is one of a plurality of through holes in the elastic body, the cable is one of a plurality of cables, each of the plurality of through holes receives one of the plurality of cables.

12. The seal according to claim 11, wherein the elastic body of the seal has a cuboid shape, a length direction and a width direction of the elastic body are respectively parallel to the minor axis and the major axis of the inner contour line of the inner sealing rib, and a thickness direction of the elastic body is parallel to an axial direction of the through hole.

13. The seal according to claim 12, wherein the plurality of through holes are arranged in rows and columns in the length direction and the width direction of the elastic body.

14. The seal according to claim 12, further comprising an outer sealing rib formed circumferentially on an outer peripheral surface of the elastic body, the outer sealing rib interference fit with an inner peripheral surface of a rear port of an insulating housing of a connector to seal with the insulating housing.

15. The seal according to claim 14, wherein the outer sealing rib is one of a plurality of outer sealing ribs on the outer peripheral surface of the elastic body, the plurality of outer sealing ribs are spaced apart in the thickness direction of the elastic body and are all in interference fit with the inner peripheral surface of the rear port of the insulating housing.

16. The seal according to claim 1, wherein the seal is a one-piece injection molded part.

17. A connector, comprising:
an insulating housing having a rear port;
a cable assembly including a cable and a terminal fixed on an end of the cable; and
a seal mounted in the rear port of the insulating housing, the seal including an elastic body having a through hole receiving the terminal with the cable and an inner sealing rib extending circumferentially around the through hole and interference fit with an outer peripheral surface of the cable to form a seal with the cable, the seal is sleeved on the cable, an inner contour line of the inner sealing rib is elliptical, a major axis and a minor axis of the inner contour line respectively correspond to a major side and a minor side of a rectangular section of the terminal.

18. The connector according to claim 17, wherein the seal has an outer sealing rib interference fit with an inner peripheral surface of the rear port of the insulating housing to seal with the insulating housing.

19. The connector according to claim 17, wherein the through hole is one of a plurality of through holes of the seal and the cable assembly is one of a plurality of cable assemblies that each pass through one of the through holes of the seal.
